(19) United States
(12) Patent Application Publication
(10) Pub. No.: US 2024/0311861 A1
(43) Pub. Date: Sep. 19, 2024

(54) REAL-TIME MARKETPLACE FOR COMPETITIVE PAY

(71) Applicant: ApolloFactor, Inc., Lyons, CO (US)

(72) Inventors: Richard Lear, Lyons, CO (US); Timothy Skaggs, Lexington, KY (US); Kateryna Nesvit, Arlington, VA (US)

(21) Appl. No.: 18/675,420

(22) Filed: May 28, 2024

Related U.S. Application Data
(63) Continuation of application No. 17/810,247, filed on Jun. 30, 2022.
Application No. 17/810,247 is a continuation-in-part of application No. 17/644,546, filed on Dec. 15, 2021, now abandoned.
(60) Provisional application No. 63/127,886, filed on Dec. 18, 2020.

(51) Int. Cl. G06Q 30/0201; G06Q 10/1053

(52) U.S. Cl. CPC G06Q 30/0206; G06Q 10/1053

(57) ABSTRACT

A compensation information system (100) includes a platform (102) that can be accessed by a variety of users including applicants (104), employers (106), and recruiters (111). The platform (102) includes a processing module (112), that can implement AI/ML logic, and compensation models (116) may be statistically derived models developed based on information from a variety of sources including salary surveys, applicants, companies, employees, recruiters, and the like. The system (100) can provide compensation values based on the attributes or skill sets of individual applicants. The processing module 112 is operative to receive queries from users, generate closing price estimates responsive to the queries, and to generate reports.

### CROSS REFERENCE TO RELATED APPLICATIONS

This application is a continuation of U.S. patent application Ser. No. 17/810,247, entitled “REAL-TIME MARKETPLACE FOR COMPETITIVE PAY”, filed Jun. 30, 2022, which is a continuation-in-part of U.S. patent application Ser. No. 17/644,546, entitled “REAL-TIME MARKETPLACE FOR COMPETITIVE PAY”, filed Dec. 15, 2021, which claims benefit of U.S. Provisional Application No. 63/127,886, entitled “REAL-TIME MARKETPLACE FOR COMPETITIVE PAY”, filed Dec. 18, 2020. The contents of the above identified applications are incorporated herein by reference in their entireties.

### FIELD OF THE INVENTION

The present invention relates generally to providing compensation information to job applicants, hiring teams, recruiters, or other stakeholders and, in particular, to a system for establishing a real-time marketplace for competitive pay including predicting market closing prices for compensation.

### BACKGROUND OF THE INVENTION

One obstacle to implementing an efficient market for talent is the lack of reliable compensation information. In the United States, there is no single, reliable source for compensation information in most labor markets. The problem is even more pronounced in heterogeneous, highly fragmented talent markets such as those for professionals and executives in highly technical fields. As a result, the stakeholders in these markets, including job applicants, hiring teams, recruiters, and others, establish compensation objectives, make offers, or enter into negotiations without reliable compensation information.

Studies have shown that this has resulted in a pay perception gap. According to some analyses, companies may underestimate the market for compensation by as much as 15-20%. On the other hand, applicants (who may only have access to anecdotal information concerning compensation) may overestimate their value. The result is that the pay gap perception between applicants and companies may be 40% or more in some cases. This can lead to missed opportunities or financial and cultural costs due to over or under compensation.

There are some sources of compensation information that may be consulted by stakeholders. Companies may rely on compensation surveys to identify a compensation target for a defined position. However, this information can be costly to access and may be unavailable, as a practical matter, to smaller companies and most applicants. In many cases, the smaller companies and applicants are forced to rely on job websites or anecdotal information. In any case, such websites, anecdotal sources, and even salary surveys are based on information that is not current and quickly becomes outdated or is otherwise unreliable. In particular, such information has limited value in certain quickly changing markets.

### SUMMARY OF THE INVENTION

The present invention relates to a system and associated functionality for improving the availability and quality of compensation information for stakeholders. In particular, the invention establishes a real-time marketplace for competitive pay and enables accurate prediction of market closing prices for compensation, i.e., substantially real-time or at least near future compensation values. The invention leverages various sources of compensation information to develop compensation models and, in certain implementations, employs sophisticated processing including, for example, artificial intelligence (AI) and machine learning (ML) to estimate market closing prices. This not only allows for market closing price estimation but also enables fine resolution of compensation metrics with respect to markets, industries, entity stages, locations, positions, and individual attributes and skill sets.

In accordance with one aspect of the present invention, a system and associated methodology (“utility”) are provided for generating predictive compensation information; that is, closing price estimates for compensation. The system involves a platform (e.g., a cloud-based platform) that can be accessed by stakeholders using a phone, tablet computer, laptop/desktop computer or other user device. The utility involves obtaining market information concerning a compensation market of interest and establishing a compensation model for the compensation market. The platform can then receive a query concerning a compensation value for a defined position and a predictive compensation module can use the compensation model and the market information to predict a closing price estimate responsive to the query. In this manner, a variety of stakeholders can efficiently obtain closing price estimates for compensation.

For example, the compensation model may be a statistically derived model covering one or more standardized position descriptions in a defined market vertical. The market information may be derived from a variety of sources including, for example, companies, applicants, employees, job surveys, job listing services, and recruiters. Such information may be analyzed in relation to specific industries, entity stages (e.g., start-up, early stage, public company, etc.), geographical location, and other factors. Moreover, the models and processing may be continually evolving based on market signals (e.g., compensation information provided by users) such that market signals can affect estimates in substantially real-time. The system encourages feedback from users and is self-propagating. Moreover, the system can process and correlate various components of compensation including base compensation, bonus or incentive compensation, variable compensation, equity incentives and the like. The platform can then receive information from these sources concerning compensation for certain source positions (positions of interest to the source of the information or for which the source otherwise has compensation information) and map the source positions to one or more of the standardized position descriptions. The system can also ingest information regarding the attributes or skill sets of an applicant related to the query. Such applicant information may be explicitly entered by the applicant or other user, extracted from resumes, websites, or other sources, or inferred by processing logic based on publicly available or proprietary data sources. This information can then be processed by a processing module employing AI and ML, as described in more detail below, to provide position and applicants specific compensation values in relation to estimated closing time prices. Such processing can provide meaningful estimates even in sparse data environments as well as evolving models and estimates based on market signals.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a schematic diagram of a compensation information system in accordance with the present invention;

FIG. 2 is a block diagram illustrating certain functionality of the compensation information system of FIG. 1;

FIG. 3 is a schematic diagram of a further compensation information system in accordance with the present invention;

FIG. 4 illustrates a Cyborg system in accordance with the present invention;

FIG. 5 illustrates a data science platform in accordance with the present invention;

FIG. 6 illustrates a combined Cyborg data science platform in accordance with the present invention;

FIGS. 7-9 illustrate sample user interface screens in accordance with the present invention.

FIG. 10 shows an example of a table including certain position information in accordance with the present invention;

FIGS. 11A-11B show data modeling level categories in accordance with the present invention;

FIG. 12 shows data modeling level categories for connected values in accordance with the present invention;

FIG. 13 shows an example of level categories for corrected and predicted data for engineering roles in accordance with the present invention; and

FIG. 14 illustrates certain confidence levels in accordance with the present invention.

### DETAILED DESCRIPTION

The present invention relates to a system that provides a real-time marketplace for competitive pay including closing price estimates for compensation. The system can be used by a variety of stakeholders for a variety of purposes. Moreover, a variety of information sources and processing technologies can be used to provide closing time estimates in accordance with the present invention. In the following description, the invention is set forth in relation to specific contexts for providing closing price estimates for new hires. Specific information sources and AI/ML processing modules are disclosed in this regard. While these are believed to represent useful implementations, the invention is not limited to these contexts or implementations. Accordingly, the following description should be understood as illustrative and not by way of limitation.

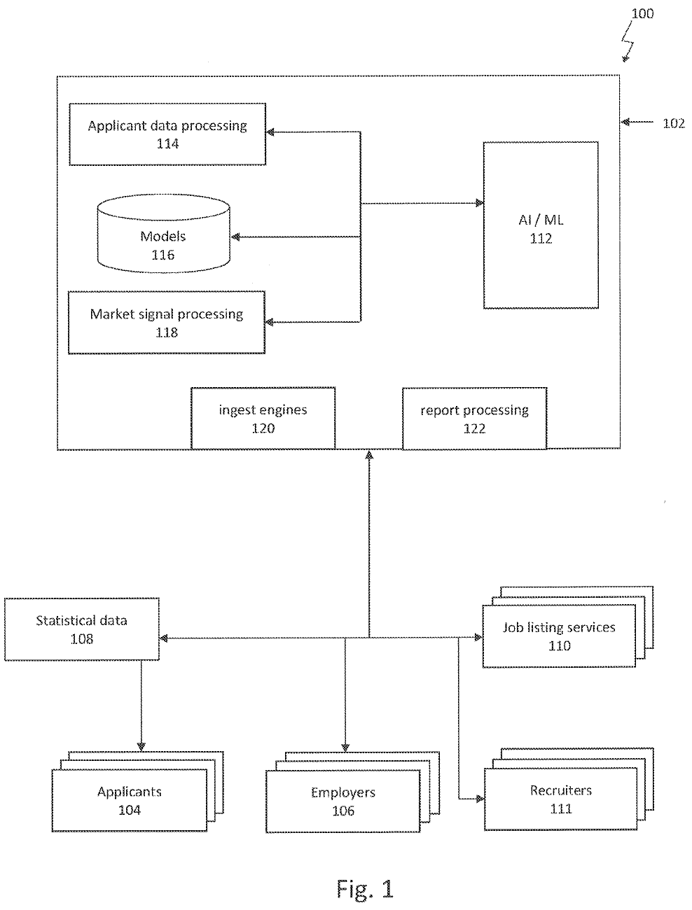

Referring to FIG. 1, a compensation information system is generally identified by reference numeral 100. The illustrated system 100 includes a platform 102 that can be accessed by a variety of users including applicants 104, employers 106, and recruiters 111. The platform 102 can be accessed via a local area network or wide area network among other possibilities. In one implementation, the platform 102 is a cloud-based platform that may be distributed over multiple machines at a single or multiple locations. It will be appreciated that the cloud-based implementation provides a number of conveniences related to remote access and continual updating of information from a variety of sources. The users may access the platform 102 via a variety of user devices including, for example, phones, tablet computers, laptop/desktop computers, IoT devices and the like. As will be described in more detail below, the platform 102 may also access and provide outputs to sources of statistical data 108 and may access or provide information to various job listing services 110 such as job web sites.

The illustrated platform 102 includes a processing module 112 that, in the illustrated embodiment, implements AI/ML logic as will be described in more detail below. The platform 102 also includes a number of compensation models 116. The compensation models 116 may be statistically derived models developed based on information from a variety of sources including salary surveys, applicants, companies, employees, recruiters and the like. The information from these sources may be indexed to standardized position descriptions based, for example, on information provided by the sources concerning source positions. Thus, for example, positions defined by a particular company such as chief scientist, chief technology officer, software engineer, or VP-software development may be mapped to standardized position descriptions based on matching descriptors or responsibilities. Such matching may be automated or partially automated by textual analysis software and/or implemented by human operators. Specific models may be developed for defined industry verticals or other useful subdivisions of the marketplace.

The illustrated system 100 can provide compensation values based on the attributes or skill sets of individual applicants. Such information is accessed and processed by an applicant data processing module 114. In this regard, the system 100 may identify a set of metrics that are deemed to be relevant to a compensation analysis for a particular position, type of position, and/or industry. These metrics may vary based on the position, type of position and/or industry, among other considerations. Such applicant information can be provided in a variety of ways. For example, an applicant may provide information in connection with an enrollment process of the system 100. Such information may be elicited by the system 100 in a series of user interfaces that identify the position or types of positions of interest to the applicant and prompt the applicant to enter, for example, experience and skill information relevant to those positions. Alternatively, an applicant may upload a resume, curriculum vitae, a biographical text or other information describing the experience and skills of the applicant. As a further example, the system 100 may access information of an applicant from professional networking sites, public and/or proprietary data sources or other sources of information. Optionally, the system may verify user submitted information by reference to other sources of information.

In such contexts, ingest engines 120 of the platform 102 may perform a variety of processing functions. For example, the ingest engines 120 may generate user interfaces and collect information from such user interfaces to provide to the processing module 114. In other cases, the ingest engines 120 may include textual analysis logic to extract relevant information regarding, for example, experience and skills from textual sources. In still other cases, the ingest engines 120 may access external information sources based on identification information regarding an applicant to extract relevant information. In any of these cases, the resulting applicant information may be provided to the processing module 114 in attributes/value pairings, or other suitable forms, together with appropriate metadata describing the applicant information. The processing module 114 can then construct a set of applicant information relative to a relevant set of defined attributes and values for the specific compensation analysis context.

The illustrated platform further includes a market signal processing module 118. The system 100 receives signals from a variety of stakeholders including recruiters, candidates, and hiring teams. These may include user-generated pay profiles from the perspective of individual stakeholders. The processing module 118 pre-processes these signals for use by the AI/ML module 112 in training and live processing of compensation queries.

The AI/ML module 112 is operative to receive queries from stakeholders, generate closing price estimates responsive to the queries, and to generate reports. In this regard, the module 112 accesses one or more compensation models relevant to the query from the module 116, accesses applicant information from the applicant data processing module 114 and accesses any relevant signal information from processing module 118. The module 112 may implement a supervised or unsupervised machine learning process. The module 112 may initially implement a training process using training data based on real world compensation scenarios. In addition, the module 112 may receive feedback, for example, via the market signal processing module 118, regarding prior analyses to further develop the compensation models and processing. The results of an analysis in response to a query may then be processed by the report processing module 122 to provide reports to appropriate users who may or may not be the same as or limited to the user or users who submitted a query. The reports provided by the module 122 may have a format and content that is based on the nature of the query or the preferences of users. Moreover, though not shown, the platform 102 may implement a privacy module that governs what information may be provided to which users.

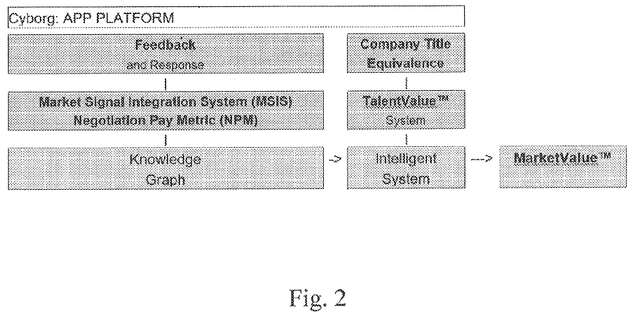

FIG. 2 is a block diagram that summarizes some of the functionality of the processing platform. As shown, the functions include a feedback and response system. This system solicits pay metrics in the form of detailed compensation packages, information outlined in user recruiter pay feedback, generated job offers, candidate compensation, and hiring team pay data. Recruiters will provide direct feedback and the platform can then display a revised prediction based on feedback.

The processing platform further includes a market signal integration and negotiation pay metrics system (MSIS). The platform will establish the currency of compensation through the MSIS. The MSIS solicits, filters, interprets, and integrates user-generated pay data into the compensation information system. The feedback system passes user-generated data to the MSIS which then compares it to a current market value prediction. The MSIS may assess the integrity of the data and then determine the credibility of the user in the context of the prediction. The data can then be assessed for the level of influence that each unit of data ought to be permitted to have on the new market value prediction. The real time market signal is then integrated into the compensation information system. Other stakeholders may provide market signals which can guide pay predictions. For example, candidates may provide signals in three ways. First, candidates are prompted to report their own current compensation in order to find their market rank. In addition, candidates are asked to set a target for their pay at the next adjustment opportunity. Finally, the platform will provide rating and recommendations for job offers. The platform can also harvest market information on actual job offers through candidate interactions. Companies may provide similar market signals including proposed target offers an actual job offers. The information from the feedback and response function and the MSIS yield a knowledge graph concerning the compensation marketplace related to a particular query.

The illustrated functionality also includes a company title equivalence function. As noted above, different companies may have different job titles corresponding to the same or similar job responsibilities and/or may associate different responsibilities with a given job title. The platform preferably obtains information describing the responsibilities and functions associated with a particular job title from a given company. These functions and responsibilities can then be matched to the corresponding functions and responsibilities of a particular defined position of a set of standardized positions. In this manner, meaningful comparisons can be made in relation to idiosyncratic job titles.

The Talent Value™ function involves a proprietary index for the value of a particular job candidate's human capital. This is analogous to a kind of credit score but for talent and experience rather than creditworthiness. It incorporates more than job qualifications. The Talent Value index incorporates a variety of factors deemed to be predictive of success. These factors may vary depending on the context of the position under consideration. Some factors that may be considered include an education factor (that may take into consideration the candidate's school, degree, and concentration/major); a quality index factor related to the companies at which a job candidate has worked; a career momentum factor measured by promotions and velocity in breadth of responsibility; an average duration factor that measures the staying power and loyalty of the candidate; and a relationship factor indicative of a variety of relationships predictive of success. It will be appreciated that many other factors are possible depending on the nature of the candidate and position. The information from the company title equivalence function and the Talent Value system, combined with the knowledge graph provide an intelligent system that can provide compensation information based on both detailed information about the marketplace and detailed information about the attributes and skills of a particular applicant. All of this information can be used by and AI/ML module to produce a final market value which represents an alignment between the unique candidate human capital and value in the marketplace for a specific role.

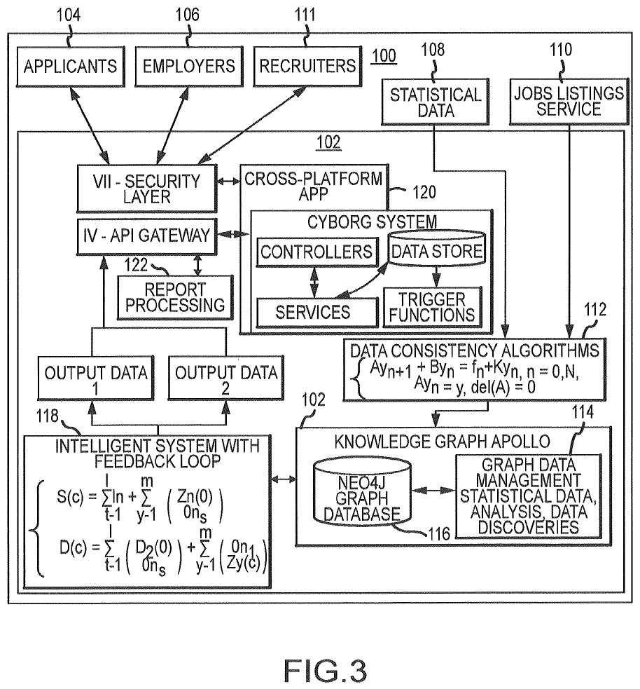

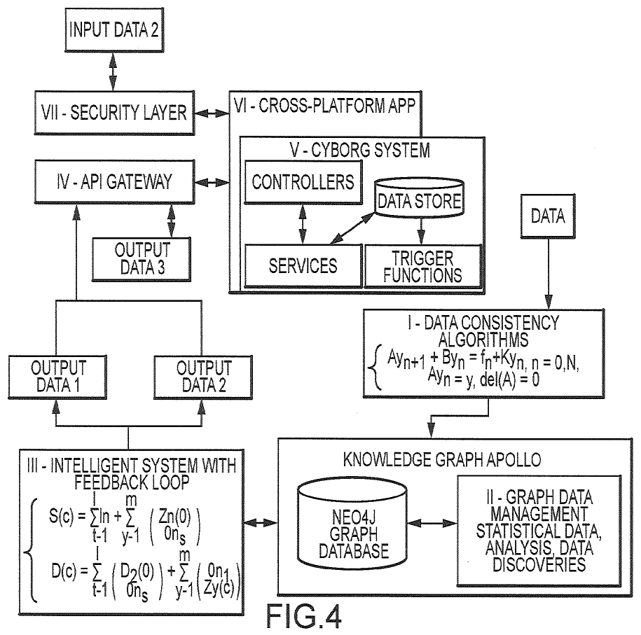

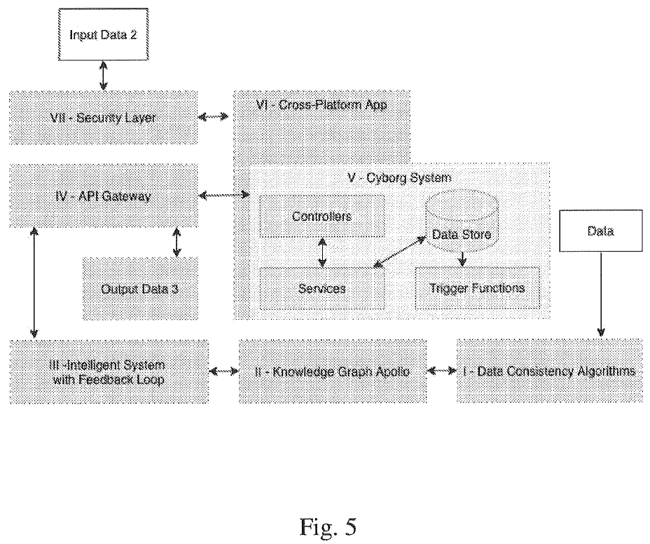

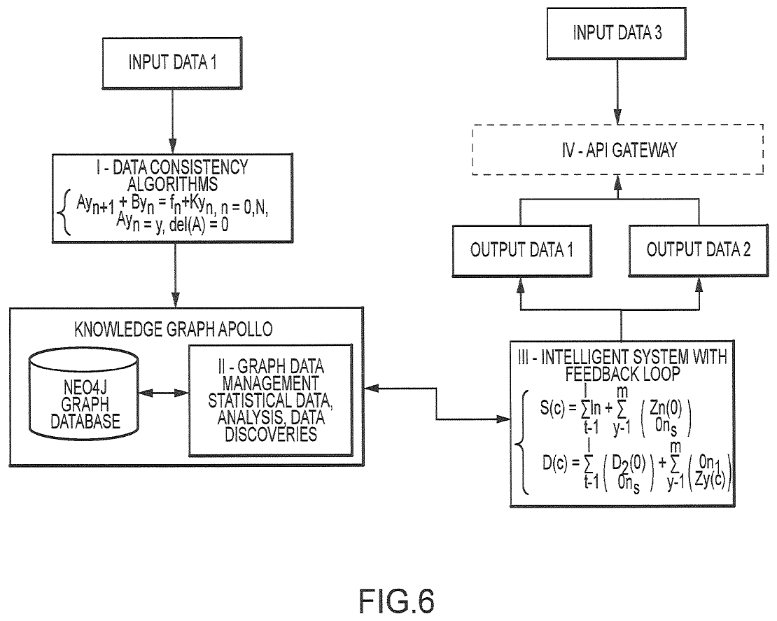

FIGS. 3-5 show a further compensation information system 100 in accordance with the present invention. In FIG. 3, components having functionality generally corresponding to that of FIG. 1 re-use the same reference numerals. The system 100 may have a variety of users including applicant 104, employers 106, and recruiters 111. These users 104, 106, and 111 interact with the cross-platform application 120 of the platform 102 via a security layer VII. The security layer performs a number of functions for ensuring secure communications and respecting privacy rules, regulations, laws, and/or policies. This includes ensuring that sensitive information is not shared as between users or published together with personally identifiable information. For example, as described herein including the appendices, users including companies may allow the platform to access company systems via a CSV or API. Information accessed in this manner may be stripped of personally identifiable information, aggregated, or otherwise processed to respect privacy and enforce policies concerning sensitive company information.

The cross-platform application 120 includes a cyborg system as will be described in more detail below. Generally, the cyborg system includes controllers, services, a data store, and trigger functions. Among other things, the cyborg system integrates corporate payroll systems, human resource information systems, and applicant tracking systems with the platform 102. A secure, encrypted system may be used in this regard to capture user data via CSV's or API's so as to allow application of numerical analysis and ML techniques while keeping all corporate and partner data private and secure.

The platform 102 may also access statistical data 108 from a variety of public or proprietary sources and information from job listing services 110. Such information may be processed using data consistency algorithms 112 to facilitate data validation and weighting and provided to a knowledge graph module. The knowledge graph module includes a graph database and a data management processor for developing statistical data, performing data analysis, and discovering data correlations, trends, or other relationships of interest. The knowledge graph module communicates with an intelligent system with feedback loop. The intelligent system can develop various compensation parameters and relationships. It will be appreciated that the compensation models and resulting factors are continually evolving based on market signals. In this regard, market signals such as compensation information from users can impact compensation models and result in updated compensation estimates. The report processing module 122 can generate reports that can be provided to users via an API and the security layer.

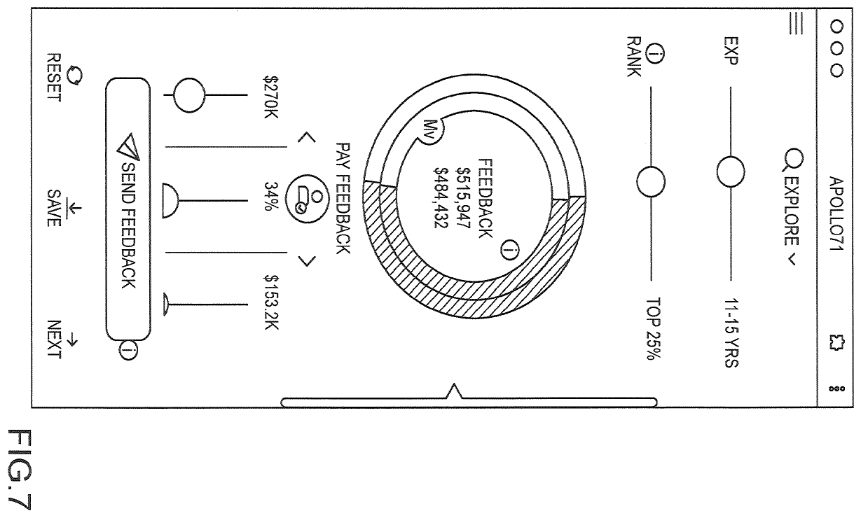

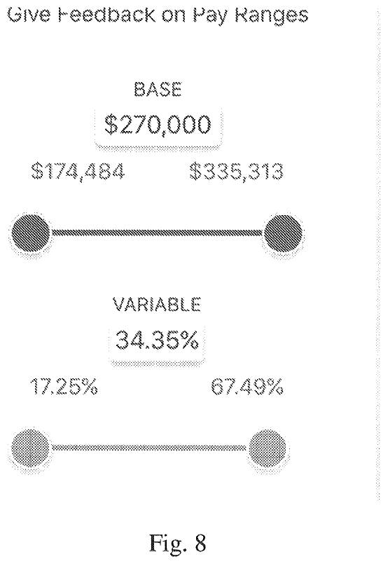

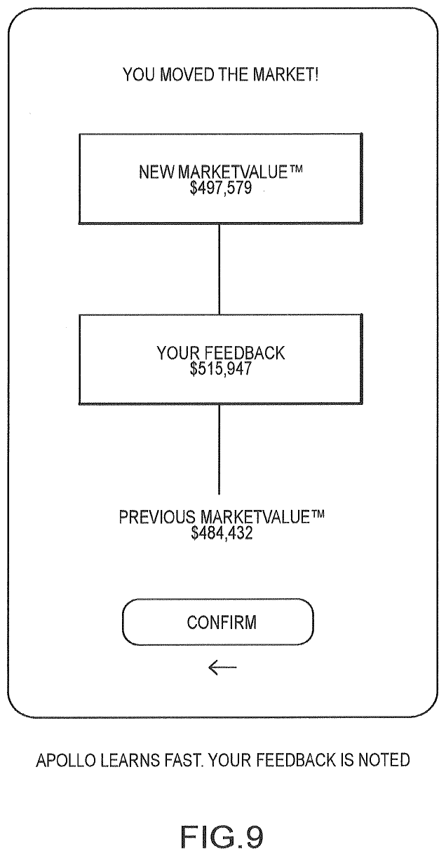

FIGS. 7-9 show examples of user interfaces that may be utilized in connection with a compensation information system in accordance with the present invention. In particular, FIG. 7 shows a user interface screen that may be used to solicit feedback from users regarding compensation. An important feature of the system is the ability to solicit feedback from users that will improve compensation estimates. In this regard, it is desirable to provide simple interfaces that provide useful information without requiring difficult or time-consuming interactions. In addition, by making the experience enjoyable for the user, users are encouraged to provide and frequently update information. FIG. 7 illustrates a screen where users can easily manipulate various components of compensation and send feedback to the system. FIG. 8 shows a further user interface screen for providing feedback concerning components of compensation. FIG. 9 shows a user interface screen where a user can see how feedback impacted the marketplace. As noted above, the system employs a feedback loop based on market signals to modify compensation estimates. In this case, the user can see what the previous market value was, what feedback was provided by the user, and what the new market value is as affected by the feedback. The operation of the compensation information system is further described below in relation to a specific product environment of the applicant, ApolloFactor Inc.

### I. Real-Time Marketplace for Competitive Pay

### AI-Marketplace for Competitive Pay

ApolloFactor reimagines compensation. Apollo7i is a compensation system, which combines a front-end app with an innovative and powerful AI-driven data platform. Apollo7i predicts pay levels with increasing accuracy for hundreds of roles at thousands of companies across the technology sector. It operates like a real-time marketplace for competitive pay.

### Competitive Pay

Competitive pay measures the level of compensation necessary to close job offers in today's job market. Our focus is on ‘new hire’ compensation metrics. Apollo7i uniquely incorporates influential factors on compensation for both companies (buyers of talent) and job candidates (sellers of talent) to predict market pay levels. For instance, Apollo7 i predicts pay for a particular role (title, level and function) at a given company in a specific location for a job candidate with unique experience and human capital factors. Apollo will be the first compensation tool to incorporate unique characteristics (factors) of job candidates when determining levels of pay. The Apollo AI platform may ultimately incorporate as many as 25 factors (features) and market signals. Each factor will be statistically demonstrated to influence market levels of compensation. Apollo7 i acts like a real-time pricing model for talent acquisition.

Apollo7 i predicts competitive pay in today's job market in as few as 2 clicks.

Apollo7 i delivers a single source of market-based compensation guidance to key stakeholders in hiring: job candidates, hiring teams and recruiters. For all users, the platform simulates an auction-style marketplace for compensation such as NASDAQ. Apollo7i leverages recognized patterns of compensation and incorporates discrete market signals from users to help inform today's prices for talent (human capital).

### Market Value™

Apollo7i gives users access to a powerful AI-driven system that leverages key factors (features) of compensation to predict Market Value™. This new, standardized pay metric, provides a transparent measure of compensation for all stakeholders. MarketValue™ includes key components of compensation: base salary, bonuses, annual equity/stock value and total pay levels for today's job market. The metric will also recognize and suggest ideal compensation mixes—a first.

Apollo's AI platform—the Intelligent System (IS)—is designed to leverage advanced mathematical methods, novel model features, human capital expertise, and the market intelligence of compensation experts to simulate market-pricing. The platform uniquely incorporates market signals, communicated by users of the software application. The Apollo platform applies AI and machine learning in combination with encoding human capital insights and integrating expert-level user-generated data to predict market pricing for pay.

### Pay Transparency

Apollo7i can create pay transparency; more granular and customized pay guidance; and highly accurate, up-to-date compensation metrics. For companies, there is less guesswork in crafting pay packages. Job candidates receive fairer, better pay outcomes. Pay transparency removes bias, enabling greater accuracy and fairness in compensation. Pay negotiations can be more efficient. The app reduces corporate costs of paying too much, or too little. Employer—employee relationships improve.

### II. Commercial Opportunity

### Lack of Universal Access and Transparency in Pay

Until now, there has been no single source for accessing creditable and transparent compensation metrics in most US labor markets. The problem is even more daunting in heterogeneous, highly-fragmented talent markets like those for professionals and executives in highly technical fields. Even the most respected data sources, such as salary surveys, are often out-of-date, imprecise, and tend to create a downward bias on compensation for new hires. Salary surveys are expensive and available to only an exclusive few insiders at larger, more mature companies. The shortfall in good pay data excludes many of the key stakeholders in the hiring process, including job candidates and recruiters. There is an asymmetric stakeholder access to credible pay data. This is a classic example of a market failure. Not surprisingly it imposes negotiating costs for all stakeholders.

### Pay Perception Gap

In professional/executive labor markets, there is often a gap in perceptions for pay. It's called the pay perception gap. According to recruiters, companies underestimate the market for compensation by up to 15-20%. Job candidates, who rely on job websites, or anecdotal information for pay guidance, typically overestimate their value. It is not uncommon to see a 40% pay perception gap.

### Value Proposition

Apollo's value proposition for our AI-Marketplace for competitive pay is twofold.

### Establishes a Standardized, Competitive Pay Metric

Apollo's AI-driven pay platform aims to establish a standardized, competitive pay metric called MarketValue™. An industry-adopted metric for market pay promises to deliver greater efficiencies for creating and negotiating pay packages. These efficiencies can mean cost savings for companies and improved career earnings for job candidates.

### Pay Transparency Benefits

Stakeholder adoption for MarketValue™ can help strip subjectivity and bias out of legacy approaches to determining compensation. The metric ensures pay transparency. A credible and competitive pay metric levels the playing field for job candidates and companies alike by delivering true “pay transparency” for all. The Apollo AI platform helps all stakeholders capture lost value in negotiating and closing job offers brought about by imprecise or limited compensation information.

### Market Opportunity

The market opportunity for Apollo7i may exceed $1.7 billion. The cost of imprecise pay metrics is high and the “sell-side” of the market for talent is greatly disadvantaged. The worldwide salary survey market stands at $1.2 billion alone. Job websites which leverage pay data to attract users are estimated to generate at least $500 million in revenue that is attributed to “compensation” features.

### Technology Sector

Apollo's initial target market is the technology sector. There are about 10 million employees in the US tech market. About 2 million are hiring managers and another 3 million change jobs every year. Apollo's collaborative platform is designed to deliver multiple user experiences, while leveraging a common data platform. Apollo7i addresses an initial market of 5 million annual users.

### Summary

Companies and candidates negotiating job offers find a paucity of good compensation data for the new hire market. Companies rely on salary surveys, which are geared to provide competitive ranges for annual pay raises. Annual increases for existing employees typically average about 3-4%. Salary surveys become out-of-date quickly. These tools provide only a rough guideline for compensating new hires. In particular, surveys fail to capture the 5-25% premium candidates receive when making a job move.

Furthermore, job seekers and most smaller companies are unable to obtain these costly, exclusive surveys. This excludes the majority of stakeholders, who seek pay data. On an annual basis, across all US sectors, more than 32 million job candidates and thousands of companies may be informationally disadvantaged.

The “buy-side” of the market (companies) may underestimate current pay, while the “sell-side” of the market (job candidates) is forced to scavenge job websites to cobble together a hazy picture of compensation. Candidates and smaller companies are handicapped by the lack of compensation transparency.

### Solution

The Apollo AI platform promises to reduce costs from imprecise compensation packages and improve market efficiencies for negotiating job offers. Job offers that are too high, or too low impose hidden costs on both businesses and candidates alike. Costs to companies from losing mid-level candidates to low job offers can range from $20-100,000 in lost productivity. Annual costs from overpaying just twenty new professional, or executive hires by just 5% can exceed $500,000.

### Product Market Fit

Achieving product market fit for Apollo7i rests with the credibility and accuracy of our pay metrics. As users come to trust MarketValue™, multiple use-cases for the product surface. Hiring teams leverage comparative-pay reports to inform fairer, more accurate job offers. Candidates use competitive pay reports to inform their own market value. They can also use these reports as a negotiation tool. These are the first steps in establishing real transparency in pay. Accuracy and transparency in pay means credible pay metrics, which, in turn, suggests a strong case for achieving Apollo7i product market fit.

### Target Customers

Apollo is an AI-marketplace for compensation. The app engages multiple stakeholders in the job offer process. Hiring managers, talent management, human resources, recruiters and job candidates all collaborate (privately) while sharing a common view of market pay. Customized interfaces will be available for each type of user. The underlying compensation metrics will be shared. Apollo7i can level the playing field and accelerate job offer negotiations.

### Competition

Competitors fall roughly into two categories: job websites and salary surveys.

### Job Websites

Job websites like Glassdoor, Payscale, Indeed and LinkedIn draw millions of users seeking guidance for compensation. Each site falls short in 1) providing precision pay guidance for new hires and 2) pinpointing real-time market compensation levels. None so far appears to use AI to predict current compensation. Instead, jobsites need substantial data to “calculate” basic compensation. Jobsites fail to use advanced math to “fill” holes left in the marketplace. 3) None offers a broad selection of search criteria to access talent markets. 4) None uses human capital factors for job candidates to determine final job offers.

### Market Pay vs. Current Pay

Job websites operate like crowd-sourced surveys. They use current pay data to produce mean/median salary results. They underestimate pay in the new hire market by 5-30%. See next section for comparison and analysis of salary surveys.

### Competitive Advantage

Predicting compensation levels is complicated. Yet, the tools aren't currently available to simplify it. Both salary survey and job website pay data are flawed and oversimplify pay.

The Apollo marketplace will be powered through user-generated data that produces market signals. These signals for compensation are informed by job participants and captured through user input on current pay, actual job offers, target pay and trends for compensation across millions of individual talent markets.

Apollo7i is the first compensation tool to pinpoint current market conditions for new hires.

### Differentiators

Precise tunable parameters define and determine compensation levels and suggests realistic mixes of base, bonuses, cash and equity in unique talent markets. Apollo7i's compensation metrics match micro-talent market parameters, including 8 proprietary company characteristics.
Includes Talent-side market factors: Apollo7i recognizes unique characteristics (factors) of job candidates (talent) as influential features in our predictive model for Market Value™.
Platform Translation: Apollo7i seamlessly predicts compensation packages across very different talent markets. The platform translates key facets of compensation across 1) stages—public to private; 2) marketspaces—SaaS to consumer electronics; and 3) location—Boston to SF to Denver. It also recognizes equivalencies 4) in title/levels across multiple company stages and sizes.

The “state of the art” for determining pay for new hires is flawed, inefficient and ready for disruption.

### Market Compensation Metrics

Market Value™ reflects nearly real-time market pay. These are pay levels in today's market. Most sources use survey, or crowd-sourced data, which can be 1-3 years out of date. No competitor is yet predicting market pay. Competitors currently predict 5-30% lower than actual job offers.

Other Shortcomings of Jobsites include using non-validated data. This is crowdsourced data which is dated, non-contextual and subject to inaccuracy. No feedback loop exists to validate or adjust the data. Finally, jobsites are built on crude statistical models that require millions of data points to predict.

### Differentiated Technology

Advanced AI and Machine Learning: Apollo captures real-time compensation metrics more effectively than surveys. Using AI strategies, machine learning, API-integrations with company human resource (HR) systems and expert feedback, Apollo more accurately predicts pay packages even where market data is sparse.

### SaaS Business Model

Users will be monetized across different products by offering various tiers of freemium models. Apollo addresses 1) hiring teams, 2) candidates and 3) compensation professionals. Freemium models build loyalty and value with free features and then offer upsells to access more powerful tools and advanced analytics. Subscriptions provide revenue streams across each stakeholder.

### III. INNOVATION: Apollo Compensation Market Simulation: Structure and Strategies

### Vision

Apolo7i will apply AI-machine learning methodologies to our statistically-derived data model to produce consistent predictions for compensation for new hires. To ensure currency, AI-machine learning and data consistency algorithms will then be applied to fresh user feedback and data fed by APIs connected to company HR systems. By leveraging market signals from new data, Apollo7i updates and tunes compensation levels to real-time competitive pay levels. This is competitive pay in today's market.

TalentValue™, which represents an index of human capital characteristics, is then applied to the initial MarketValue™ prediction to establish a final, candidate-specific Market Value-A. This metric reflects differences across job candidates in experience, capabilities, education and core human capital. Apollo7i's model for the first time enables balanced compensation predictions for unique job candidates.

The Apollo AI platform is anchored by the Intelligent System (IS), which deploys algorithms and mathematical models to predict pay levels. The IS incorporates both established and emerging mathematical relationships across a combination of influential factors (features) to peg compensation levels. The AI platform also incorporates data consistency modules (DCM) and will soon incorporate machine learning (ML) methodologies, a real-time feedback mechanism; and a sophisticated system for interpreting and incorporating market signals from user-generated compensation data.

Apollo7i will ultimately incorporate two additional systems, Company Title Equivalence (CTE) and the TalentValue™ Index (TVI). CTE serves to match industry roles to pinpointed pay bands. TalentValue™ will provide a scorecard for a job candidate's unique human capital.

### Compensation Marketplace Simulation

Apollo7i simulates a marketplace for compensation. This is our overarching innovation. Until now, no salary survey, or tool predicts market prices for competitive pay. Innovations:
Market Value™
Real-time Feedback System
Negotiation Pay Metric (NPM)
Market Signal Integration System (MSIS)
Talent Value™ (Index)/TVI System
Company Title Equivalence

### MarketValue™ Competitive Pay Metric

Market Value™ represents the predicted closing price of compensation in today's market for a given role at specific company for a prospective employee with unique experience, skills and human capital. For the first time, a real-time pay metric for new hires.

Apollo7i will leverage a combination of system features and market signals. These building blocks of our model will evolve over time and operate as the core determinants for compensation levels in our model. We have identified functional and numerical relationships between 8 influential features of compensation.

Market Value™ is currently predicted based on key features of a job opportunity, such as role (level and function), company factors and location. With additional R&D, Apollo will evolve mathematical feature relationships and incorporate additional features. New features to test and incorporate are job candidates' experience levels, competencies, education and an index for human capital called TalentValue™.

By promoting universal adoption of a standardized metric for market pay like MarketValue™, Apollo brings all stakeholders in the hiring process onto the same page, which obviates the need to bargain within estimated ranges, using salary surveys. Instead, Apollo pinpoints market value—Market Value™.

Feedback System: The chief enabler of the NPM system will be Apollo's Feedback System. This system will solicit pay metrics (market signals) in the form of detailed compensation packages, outlined in user recruiter pay feedback, generated job offers, candidate compensation and hiring team pay data.

### Real-Time Feedback

As compensation experts, recruiters will provide direct feedback on Apollo's Market Value™. Apollo will accept pay feedback, and then will instantly display a new prediction for MarketValue, based on user input. The idea is to empower “trusted” recruiters to act as market-makers.

### Market Signal System (MSS)

The Apollo7i platform will establish the currency of compensation through a Market Signal System (MSS). The MSS solicits, filters, interprets and integrates user-generated pay data into the Intelligent System. We call the market signals coming from each stakeholder: recruiters, candidates and hiring teams, Market Signals. These are user-generated pay profiles, representing distinct, and sometimes very different, stakeholder perspectives.

### The MSS: How it will Work

The Feedback system will pass user-generated data to the MSS, which then compares it to our current prediction for MarketValue™. As the system evolves, the algorithm will first assess the integrity of the data, then determine the credibility of the user in context of the prediction. Next, the new data will be assessed for the level of influence this compensation pay profile (data unit) ought to be permitted to have on the new MarketValue™ prediction. The MSS will then integrate this real-time market signal into the IS.

### Additional Market Signals

Meanwhile other stakeholders provide market signals, which can guide pay predictions. Candidates provide signals three ways. First, candidates are prompted to report their own current compensation in order to find their Market Rank. Then candidates are asked to set a target for their pay (target pay) in their next opportunity. Finally, Apollo will provide rating and recommendations for job offers. Apollo can harvest market information on actual job offers through candidate interactions. Each market signal: current pay, target pay and job offer provides a distinct class of market signal.

Companies provide similar market signals including proposed “target offers,” and actual job offers. All versions provide market signals. Here's a summary:

### Market Signals: Negotiation Pay Metrics

| | | |
|---|---|---|
| Recruiter Pay Feedback | Candidate's | Candidate's |
| | Current Pay | Target Pay |
| Company's target pay | Job Offers | Hiring Pay |

### Challenges and Risks

Capturing credible compensation feedback from users and real-time data through APIs to company HR systems are the key differentiators for Apollo. Each presents a challenge in determining what is authentic, credible, actionable and what is the quantitative relationship to Market Value™. More challenges & risks:
Selling the value to customers of a pinpointed MarketValue™ versus simply showing pay ranges.
Deploying best-in-class data acquisition strategies for high quality data to reduce user friction.
Creating a system that effectively discerns credibility of data.
Correctly interpreting market signals from stakeholder data.
Identifying key features responsible for creating a gap in predictions. When is new Feedback simply a signal of new market conditions, or a model feature relationship inaccuracy?
Determining and evolving optimal feature coefficients and functional relationships.
Correctly adjusting graph model values based on Feedback mechanisms.
Engaging stakeholders to use app, give feedback and take ownership for Apollo 7i accuracy.

TalentValue™: A proprietary index for the value of a job candidate's human capital (HC).

Imagine a kind of credit score for talent. It incorporates more than job qualifications. TalentValue™ is akin to an employment IQ. It may ultimately be a predictor of success. Key features to be investigated and integrated:
Education quality of education: school, degree (BS/MS/MBA) and concentration/major.
Quality index of companies at which a job candidate has worked.
Career momentum—measured by promotions and velocity in breadth of responsibility.
Average duration with each company—this measures “staying” power and loyalty.
Relationships—studies show that quality and variety of relationships predicts success.

### TVI System

Once TalentValue™ is established, Apollo7i produces a final MarketValue—A—which is an alignment between the unique candidate human capital—TalentValue™—and MarketValue™ for a specific role. Conceptually, TalentValue will prescribe the percentile rank for a specific candidate.

### Company Title Equivalence

Apollo7i's data platform will incorporate a system for translating titles and role levels across companies within technical areas like software development, engineering and research & development. In the tech sector, there are more than 1500 different titles across 20,000 companies that require classification. Within the context of the NSF R&D grant, Apollo will create a complex translation system that translates any title and company to the appropriate level at any other company.

The Apollo translation engine will allow companies to estimate both compensation and comparable level of any candidate, regardless of what company they work for. Customers have validated that this capability embedded in a software system could be worth thousands of dollars per year.

### Expected Advancements

Advance the Apollo7i AI-Platform to predict with increasing accuracy and consistency. (−2-4%).
Create/Deploy Feedback System: easy to use, engaging, even gamified real-time feedback.
Negotiation Pay Metric: establish formula and deploy.
Market Signal System (MSS) test and build the MSS. Ensure perpetual learning and establish a self-propagating system of high intelligence.
Company Title Equivalence (CTE): create, test and deploy CTE.
Talent Value™ Index and TVS: derive mathematical model, test, build and integrate Talent Value.

### IV Roadmap

ApolloFactor is a 3-year-old, seed-funded startup. Our vision is to create a marketplace for compensation which establishes a universal pay metric that reflects real-time, competitive pay. The data platform will leverage AI and tap expert-based, user-generated pay metrics to create greater accuracy and currency for compensation. We seek to revolutionize compensation and deliver pay transparency. Apollo fuses human capital expertise with a high-caliber scientific/technical team, including five mathematicians/scientists (PhDs). We leverage expertise in compensation, engineering, data science and mathematics.

### Phase 1: Universal App.

Our first product, Apollo7i-Recruiter, will launch in mobile format. The launch will be followed by a universal mobile app for companies, hiring teams and candidates. Each user will have a unique experience and access a common data platform. Recruiters play three key roles: 1) power users, who provide usability feedback; 2) data sources for real-time compensation conditions; and 3) advocates for the application. Recruiters act as Apollo's distribution network.

### Phase 2: B2B

Apollo launches Company compensation dashboards to businesses. API's are deployed to HR-systems to access real-time data. Dashboards incorporate AI, machine-learning and custom algorithms to deliver real-time analytics on hiring, compensation and predicted performance. Advanced and powerful compensation intelligence obviates the need for surveys, creating a new product category.

### Phase 3: Distribution

Establish partnerships for distributing MarketValue™ metric via API's to early competitors like LinkedIn, Indeed, and Glassdoor. MarketValue™ will be the to pinpoint compensation for new hires. Our mission to revolutionize compensation intelligence. As Apollo achieves scale, we plan to move to new sectors of the US economy and release our AI hiring products globally.

Apollo7i—A Real-Time Marketplace for Competitive Pay

### Core Value Proposition: Self-propagating Marketplace for Competitive Pay

Apollo7i's core innovation is an AI-marketplace for real-time competitive pay. Implicitly, this means conceiving, building and deploying a self-propagating mathematical compensation market-model (Intelligent System) built on an intuitive interface that is engaging, effortless, even fun.

The app captivates hiring teams and job candidates in order to leverage their user-generated compensation data to organically feed the marketplace and constructively evolve. Market signals in the form of pay profiles can inform the model. Among the chief challenges of our team is to solicit and validate the user pay data. The next challenge will be ensuring data integrity. Then, we must interpret the various data, carefully integrating each market signal to produce a predictable and validated effect on the market-model (IS). Finally, we must test the new market predictions across the model to ensure the correct changes have been incorporated and unintended consequences have been identified and eliminated.

### API Integrations with Company, Partner, and Customer Data

A second method of data acquisition involves the integration of corporate payroll systems, Human Resource Information Systems (HRIS) and Applicant Tracking Systems (ATS) with the Apollo data platform. Apollo will use a secure, encrypted system such as a Secure Data Exchange (SDE) to capture user data through CSVs or API's to apply numerical analysis and Machine Learning techniques while keeping all corporate or partner data private and secure. No one has yet deployed such an approach.

### First PRODUCT: An Innovative Real-Time, Self-Propagating Market for Compensation!

This AI-driven product is highly patentable. With this data platform infrastructure, Apollo will deliver:
First real-time marketplace for competitive pay. (this is today's closing market).
First discrete market value for a given role at a given company: MarketValue™
First self-propagating model for compensation.
First AI-ML-driven compensation technology.
First tool that incorporates expert-user pay feedback to inform new market predictions.
First to use company “stage” as a feature. Most use only size of company (revenue or #employees).
First to translate equity packages from shares, or percent to annual equity value in dollars ($).

### PRODUCT DETAILS and Timeline

Apollo7i 1.0 mobile for recruiters:
I. Build and deploy a self-propagating MVP marketplace for competitive pay.
   a Recruiter Mobile App for Executive Compensation.
      i. Intelligent System associates 1-2) level, function, 3) stage, and 4) percentile rank with pay metrics. Built on Neo4j.
      ii. Intelligent System predicts using 5) experience level, 6) location (region), 7) company size (revenue/employees) & 8) Market Space.
      iii. DCA: Data Consistency algorithms learn compensation marketplace patterns, establishing compensation guidelines for ranges & percentiles: base, bonus, cash, equity, and total pay.
      iv. Seed data: Public, Private; Director to C-level. Some ICs.
      V. User-friendly Interface to explore pay data across 8 features.
      vi. Engaging and User-friendly Pay Feedback tool.
      vii. Pay Feedback data acquisition allows recruiters (users) to provide practical pay profile alternatives. Lower boundary on base. (TBD). Possible upward boundary. Equity and Bonus may be zero. Limits on equity and bonus acceptable (TBD).
      viii. Simplified Pay Feedback tool: this 4-click tool is distributed to a portion of users to test whether a fast-acting pay feedback tool will increase interactivity and stickiness. (A-B testing tracking tool).
      ix. Pay Feedback adjusts a level-function-experience-percentile and company Pay Profile.
      x. Reports: (3) Competitive (candidate/company) and Comparative report. Tools must be obvious and easy to use.
      xi. INVITE: Stakeholder Invite Feature.

### Technical Objectives Q1:

Create company database system that integrates Crunchbase (COMPANY data source) tech companies with our own proprietary company database, which includes “competitors,” Pay Percentile Tendencies and QScore (score for quality of company).

Integrate individual compensation data from H1 B data and other sources into IS.
Isolate key (IC) titles (level/function) model—problem to be discussed.
Create Recruiter compensation data CSV integration tool.
Create data-integrity tools. Anomaly detection, DCA intelligence.
Create math and deploy Check Data Model—this is a model which uses different mathematical approaches to confirm the integrity of evolving marketplace data predictions. Use Bayesian ML and linear cube of coefficients.
Create or Model 3rd party API integration to human resource software such as HRIS, Payroll data or Applicant Tracking Systems (ATS) that hold compensation information. Date stamping will provide differing market signals for new roles or existing roles.
Identify Pay Percentile Tendency for 4000+ companies by statistical analysis of 5 million US government H1B data points.

### HIGHLY Unique

### THE MARKET SIGNAL SYSTEM (MSS): How it will Work

The Feedback system will pass user-generated data to the MSS, which then compares it to our current prediction for Market Value™ As the system evolves, the algorithm will first assess the integrity of the data, then determine the credibility of the user in context of the prediction. Next, the new data will be assessed for the level of influence this compensation pay profile (data unit) ought to be permitted to have on the new MarketValue™ prediction. The MSS will then integrate this real-time market signal into the IS.

### Additional Market Signals

Meanwhile other stakeholders provide market signals, which can guide pay predictions. Candidates provide signals three ways. First, candidates are prompted to report their own current compensation in order to find their Market Rank. Then candidates are asked to set a target for their pay (target pay) in their next opportunity. Finally, Apollo will provide rating and recommendations for job offers. Apollo can harvest market information on actual job offers through candidate interactions. Each market signal: current pay, target pay, and job offer provides a distinct class of market signal.

Companies provide similar market signals including proposed “target offers,” and actual job offers. All versions provide market signals. Here's a summary:

### Market Signals: Negotiation Pay Metrics

| | | |
|---|---|---|
| Recruiter Pay Feedback | Candidate's | Candidate's |
| | Current Pay | Target Pay |
| Company's Target Pay | Job Offers | Hiring Pay |

Mathematical models for ApolloFactor Inc.

Economical-mathematical model

Labor markets have demand and supply curves, just like markets for any items. The law of demand applies in labor markets this way:
A higher salary or wage that is, a higher price in the labor market leads to a decrease in the quantity of labor demanded by employers, while a lower salary or wage leads to an increase in the amount of work required.
The law of supply functions in labor markets: a higher price for labor leads to a higher quantity of labor supplied; a lower price leads to a lower quantity supplied.

When the price of labor is not balanced [symbol] the natural economic model tends to move salaries to the balance.

In a situation of excess supply in the labor market with many applicants for every job opening, employers will have an incentive to offer lower wages than they otherwise would have.
1.1 Introduction
1.2 Example
1.3 Model

### 2. Data Consistency Algorithms

2.1 Pre-processing
   2.1.1 Simplify Level and Function
2.2 Normalization
   2.2.1 Normalization Year
   2.2.2 Normalization by Region
   2.2.3 Normalization by Market Space
2.3 Correct and set Variable Percent
   2.3.1 Problem Statement
   2.3.2 Mathematical model
   2.3.3 Data Modeling
   2.3.4 Algorithm
   2.3.5 Numerical results
2.4 Correct and predict Stages
   2.4.1 Problem Statement
   2.4.2 Mathematical model
   2.4.3 Data Modeling
   2.4.4 Algorithm
2.4.5 Numerical results
2.5 Correct and predict Percentiles
   2.5.1 Problem Statement
   2.5.2 Mathematical model
   2.5.3 Data Modeling
   2.5.4 Algorithm
   2.5.5 Numerical results
2.6 Correct and predict Levels
   2.6.1 Problem Statement

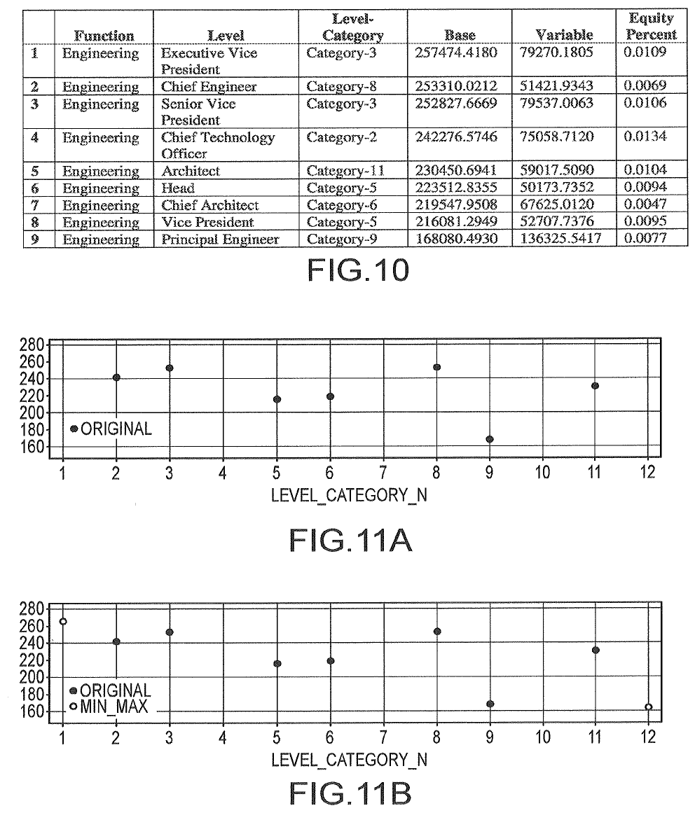

FIG. 10 shows an example of a table including certain level categories with assorted position information in accordance with the present invention.

Goal: Order the Compensation Data in a sequence to the Level categories.

Compensation Data divided to 12 categories from max to min.

Each Level category contains a list of Levels.
Source data frame with Pay Profiles should be grouped by Level categories.
After grouping, the data frame should be sorted in descending order to see the right order of Level category.
The problem appears when we see in a grouped and sorted data frame that the order of Level Categories is not ascending or mixed.
The right order should go from Level category 1 to Level category 12.
   We need to establish the correct sequence of Level categories by re-calculating the compensation pay profiles.
   2.6.2 Mathematical model

Table 4.1 shows the notation of the concepts to proposed approach.

The settings of corrected Compensation Pay will be inside each Function fq, where q={1, . . . , m} and for certain Stage sr, where t=1̅,̅9̅.

Let's consider a set of Level Categories {}, which is incorrect by order for certain Function fq and Stage st.

The original Compensation Pay for each Level Category is defined as {c_{1,j}⁰, c_{2,j}⁰, c_{3,j}⁰,}, j=1̅,̅p̅.

TABLE 2.1
Summary of Notations

| Symbol | Description |
|---|---|
| l̅ = {l₁, . . . , lₖ, . . . , lₙ} | vector of Levels, where k = {1, . . . , n} |
| l̅^̅{̅c̅}̅ = {l₁^{c}, . . . , lⱼ^{c}, . . . , l₁₂^{c}} | Level Categories, where j = 1̅.̅1̅2̅ |
| f̅ = {f₁, . . . ,f_{q}, . . . , fₘ} | vector of Functions, where q = {1, . . . , m} |
| s̅ = {s₁, . . . , sₜ, . . . , s_{g}} | vector of Stages, where t = 1̅.̅9̅ |
| c̅⁰̅ = {c₁⁰, c₂⁰, c₃⁰} | vector of original Compensation Pay: Base, Variable, Equity Percent |
| c̅ = {c₁, c₂, c₃} | vector of corrected Compensation Pay: Base, Variable, Equity Percent |

Assume we have {lᵢ}ᵢ₌₁^{p} Level Categories that are incorrect by order, where p>2. We need to correct p Level Categories and predict the rest Compensation Pay Profiles for j Level Categories, where j=12−p.

First, we need to establish the block where the function will be created and define the range of data.
2.6.3 Data Modeling

FIG. 11A and 11B show data modeling level categories in accordance with the present invention.
2.6.4 Algorithm
2.6.5 Numerical results

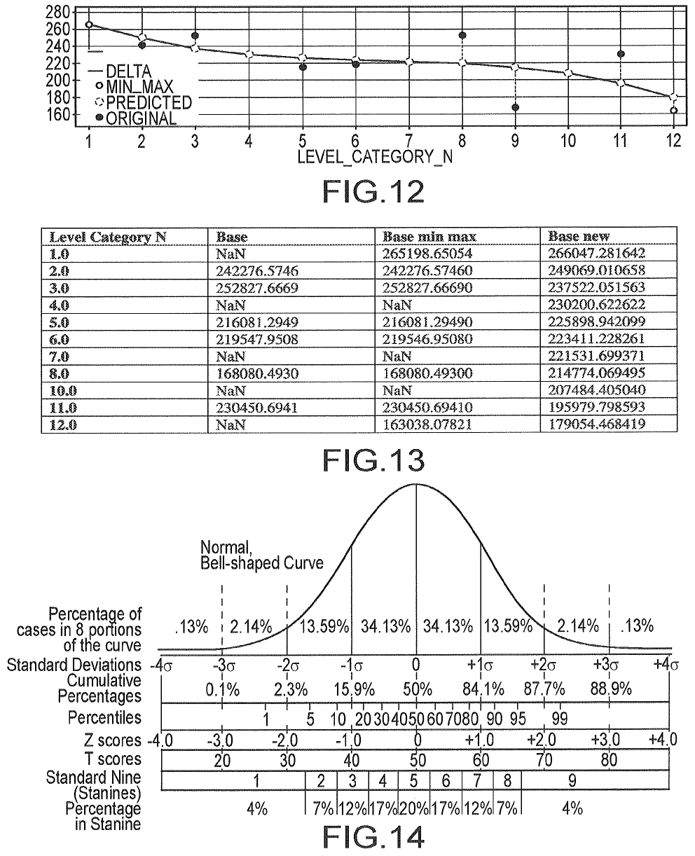

FIG. 12 shows data modeling level categories for connected values in accordance with the present invention.

FIG. 13 shows an example of level categories for corrected and predicted data for engineering roles in accordance with the present invention.

### 3. Market Value System

Formulation problem can be described by a descriptor controlled systems with discrete iterations:

$$\\ \begin{matrix}{Ay}_{n + 1} + {By}_{n} = {f}_{n} + {Ku}_{n} , n = \overline{0 , N ,} & ( 3.1 )\end{matrix}$$

$$\\ \begin{matrix}{A}_{y 0} = g , & ( 3.2 )\end{matrix}$$

where each iteration n is a state of data on a certain step of data pre-processing; matrices A, B are (m×m), K−(m×r). Control of the system (3.1) made by

$$\\ \begin{matrix}\{ {u}_{0} , {u}_{1} , … , {u}_{i} , … , {u}_{n} , {u}_{n - 1} , {u}_{n} \} , {u}_{i} ∈ {ℝ}^{n} . & ( 3.3 )\end{matrix}$$

The complexity of solving (3.1-3.2) system gets when det(A)=0 that means the matrix is not invertible using standard numerical approaches.

Studying the problem of optimal control of discrete descriptor systems with quadratic performance we consider the method of spectral projections of the type and Riesz method based on SVD coordinate system. A new result concerning the problem of minimizing the functional quality of a more general form:

$$\\ \begin{matrix}J ( u ) = < Ry , y {>}_{{R}^{{}_{} m ( N + 1 )}} + < Fu , u {>}_{{R}^{{}_{} r ( N + 1 )}} , & ( 3.4 )\end{matrix}$$

where R∈ [symbol] ^{m(N+1)}, F∈ [symbol] ^{r(N+1)}: R≥αI, F≥αI, ═>0 and where I is identity matrix.

Matrices A, B, K are block-matrices where each block is representing features: the year when the data has been collected, market space from which the data were taken, the region of where this datapoint gathered, levels of a certain role, the function of the candidate, and others. Using the method of spectral projectors of the type Riesz to obtain direct expansions of space

$$\\ \begin{matrix}{ℝ}^{m} = {X}_{1}^{{}_{} *} + {X}_{2} = {Y}_{1}^{{}_{} *} + {Y}_{2} , & ( 3.5 )\end{matrix}$$

where we can define projectors P₁, Q₁ and additional projectors P₂, Q₂:

$${P}_{1} = \frac{1}{2 π i} {∮}_{c}^{.} R ( λ ) Ad λ , {P}_{2} = I - {P}_{1} , \qquad ( 3.6 )$$

$${Q}_{1} = \frac{1}{2 π i} {∮}_{c}^{.} AR ( λ ) d λ , {Q}_{2} = I - {Q}_{1} , \\ where \qquad ( 3.7 )$$

$$R ( λ ) = {R}_{A} ( λ ) = {( λ A + B )}^{- 1} , \\ and \qquad ( 3.8 )$$

$${∀}_{χ} ∈ {ℝ}^{m} : {P}_{1 χ} ∈ {X}_{1} , {P}_{2 χ} ∈ {X}_{2} , {Q}_{1 χ} ∈ {Y}_{1} , {Q}_{2 χ} ∈ {Y}_{2} . \qquad ( 3.9 )$$

Then the unique solution can be represented in the following form

$${y}_{0} = {G}^{- 1} [ g + {Q}_{2} ( {f}_{0} + {Ku}_{0} ) ] , \qquad ( 3.1 )$$

$${y}_{n} = {G}^{- 1} [ {( - {BG}^{- 1} )}^{n} g + {\sum }_{k = 0}^{n - 1} {( - {BG}^{- 1} )}^{n - 1 - k} {Q}_{1} ( {f}_{k} + {Ku}_{k} ) + {Q}_{2} ( {f}_{n} + {Ku}_{n} ) ] , n = \overline{1 , N ,} \qquad ( 3.11 )$$

where G=A+BP₂, ∀g∈A [symbol] ^{m}, n=1̅,̅ N̅.

### 4. Feedback Platform

Goal: Platform responds to a user's feedback on pay profiles.
User (recruiter) adjusts target, compensation which differs from MarketValue.
The feedback loop:
user see the MarketValue⇒user gives feedback to knowledge graph⇒feedback platform re-adjusts the data [symbol] user see the new Market Value⇒⇒new User's behaviour⇒new Actions⇒new Data⇒. . .
4.1 Feedback trigger
Table 4.1 shows the notation of the concepts to proposed approach

TABLE 4.1
Summary of Notations

| Symbol | Description |
|---|---|
| ū = {u₁, . . . , uᵢ, . . . , uₚ} | vector of Users, where i = {1, . . . , p} |
| l̅ = {l₁, . . . , lₖ, . . . , lₙ} | vector of Levels, where k = {1, . . . , n} |
| f̅ = {f₁, . . . , f_{q}, . . . , fₘ} | vector of Functions, where q = {1, . . . , m} |
| s̅ = {s₁, . . . , sₜ, . . . , s₉} | vector of Stages, where t = 1̅.̅9̅ |
| p̅ = {p₁, . . . , pᵣ, ... , p₅} | vector of Percentiles, where r = 1̅.̅5̅ |
| c̅ = {c₁, c₂, c₃} | vector of Compensation Pay: Base, Variable, Equity |
| dᵢ | confidence in feedback for i^{th} User |
| a̅ⱼ̅(dᵢ) | vector of influential coefficients to shift the average for j^{th} |
| | Compensation Pay for i^{th} User |
| MV_{cj} | MarketValue of j-th component of the Compensation Pay, |
| | where j = 1̅.̅3̅ |
| TP_{cj} | TargetPay of j-th component of the Compensation Pay, where |
| | j = 1̅.̅3̅ |
| FV_{cj}^{max} | Feedback Value max value of j-th component of the |
| | Compensation Pay, where j = 1̅.̅3̅ |
| FV_{cj}^{min} | Feedback Value min value of j-th component of the |
| | Compensation Pay, where j = 1̅.̅3̅ |

For i-th, User uᵢ, i={1, . . . , p} the re-adjustment for each Compensation Pay will have the same model. The solution will be provided for one j-th Component of Compensation Pay cj which will be used for c={c₁, c₂, c₃} with corresponding influential coefficient aⱼ(dᵢ) from ā(dᵢ)={a₁(dᵢ), a₂(dᵢ), a₃(dᵢ)}.

The triple pair of Level, Function, and Stage (lₖ, f_{q}, sₜ) produce a vector of 5 percentiles for each compensation pay component c̅j̅=(c_{j,p1}, . . . , c_{j,pr}, . . . , c_{j,p5}), j=1̅,̅3̅.

Based on Market Value, TargetPay and Feedback need to calculate the Compensation Pay.

For each triple pair (lₖ, f_{q}, sₜ) we are using the statistical values of MarketValue mean:

$$M {V}_{mean , j} = \frac{1}{5} {\sum }_{r = 1}^{5} M V {c}_{j , pr} , j = \overline{1 , 3 ,} \qquad ( 4.1 )$$

standard deviation:

$$M {V}_{sigma , j} = \sqrt{\frac{{\sum }_{r = 1}^{5} {( M {V}_{cj , pr} - M {V}_{mean , j} )}^{2}}{5}} , j = \overline{1 , 3} \qquad ( 4.2 )$$

We assume that the standard deviation before a user gave feedback and after is the same but the mean is shifted. The j-th User has set a TargetPay on 60th percentile, min range on 25th and max range on 100th.

Need to translate the user's feedback of 60th percentile to 50th percentile based on the provided ranges of data. Then using interpolation approach between 3 data points: FV_{cj}^{max}, TP_{cj}, FV_{cj}^{min} we need to solve the linear system:

$$\{ \begin{matrix}{x}_{1} \cdot {25}^{2} + {x}_{2} \cdot 25 + {x}_{3} = F {V}_{cj}^{min} , j = \overline{1 , 3 ,} \\ {x}_{1} \cdot {60}^{2} + {x}_{2} \cdot 60 + {x}_{3} - T {P}_{cj} , j = \overline{1 , 3 ,} \\ {x}_{1} \cdot {100}^{2} + {x}_{2} \cdot 100 + {x}_{3} = F {V}_{cj}^{min} , j = \overline{1 , 3.}\end{matrix} \qquad ( 4.3 )$$

Solving the system (4.3) the values x₁, x₂, x₃ have the following form:

$$\{ \begin{matrix}{x}_{1} = \frac{F {V}_{cj}^{min}}{2625} - \frac{T {P}_{cj}}{1400} + \frac{F {V}_{cj}^{max}}{3000} , j = \overline{1 , 3 ,} \\ {x}_{2} = \frac{32 \cdot F {V}_{cj}^{min}}{525} - \frac{5 \cdot T {P}_{cj}}{56} + \frac{17 \cdot F {V}_{cj}^{max}}{600} , j = \overline{1 , 3 ,} \\ {x}_{3} = \frac{16 \cdot F {V}_{cj}^{min}}{7} - \frac{25 \cdot T {P}_{cj}}{14} + \frac{F {V}_{cj}^{max}}{2} , j = \overline{1 , 3.}\end{matrix} \qquad ( 4.4 )$$

Then the value of the 50^{th} percentile will be represented as

$$F {B}_{mcan , j} = {x}_{1} \cdot {50}^{2} + {x}_{2} \cdot 50 + {x}_{3} , j = \overline{1 , 3.} \qquad ( 4.5 )$$

Substituting (4.4) to (4.5) we derived:

$$F {B}_{mcan , j} = \frac{4 \cdot F {V}_{cj}^{min}}{21} + \frac{25 \cdot T {P}_{cj}}{28} - \frac{F {V}_{cj}^{max}}{12} , j = \overline{1 , 3.} \qquad ( 4.6 )$$

To re-adjust the new mean for each triple (lₖ, f_{q}, sₜ) we use influential coefficients {a₁, a₂, a₃} corresponding to each pay component {c₁, c₂, c₃} where the list of available percentiles are [0, 25, 50, 75, 100].

Then the new 50^{th} percentile Market Value using formulas (4.1), (4.6) will be calculated by next formula:

$${c}_{j , p 3} = M {V}_{mean , j} + ( F {B}_{mean , j} - M {V}_{mean , j} ) \cdot {a}_{j} ( {d}_{i} ) , j = \overline{1 , 3 ,} \qquad ( 4.7 )$$

Where [0, 25, 50, 75, 100]⇒[p₁, p₂, p₃, p₄, p₅] and dᵢ is confidence of i^{th} User in the given feedback.

To re-define the c_{j,p1},c_{j,p5} which corresponds to 0^{th}, 100^{th} percentiles, namely, the full range where the triple (lₖ, f_{q}, sₜ) located, we are using the confidence interval. This is shown in FIG. 14 which illustrates certain confidence levels in accordance with the present invention.

Confidence interval a type of estimate computed from the statistics of the observed data. This proposes a range of plausible values for an unknown parameter. In our case it's mean.

We don't know the true value of mean for the triple (lₖ, f_{q}, sₜ). That's why we assume it's shifted and we re-adjust it from user's feedback. Re-calculated interval has an associated confidence level that the true parameter is in the proposed range.

Given observations, a valid confidence interval has a probability of containing the true underlying parameter. Factors affecting the width of the confidence interval include the size of the sample, the confidence level, and the variability in the sample.

For known standard deviation (4.2) and calculated mean (4.7) the confidence interval has next representation:

$$( {c}_{j , p 3} - {z}^{*} \frac{M {V}_{sigma , j}}{\sqrt{5}} ; {c}_{j , p 3} + {z}^{*} \frac{M {V}_{sigma , j}}{\sqrt{5}} ) , j = \overline{1 , 3 ,} \\ where \frac{γ}{2} = Φ ( {z}^{*} ) , \qquad ( 4.8 )$$

use 5 is the size of the sample because p={pᵣ}ᵣ₌₁⁵.

With 80.64% probability we estimate the re-adjusted mean in confidence interval (4.8) then z* defined as

$$Φ ( {z}^{*} ) = \frac{0.8064}{2} = 0.4032 , \\ ⇒ {z}^{*} \approx 1.3 , \qquad ( 4.9 )$$

where Φ(z*) is integral of normal curve:

$$Φ ( {z}^{*} ) = \frac{1}{\sqrt{2 π}} {\int }_{0}^{{z}^{*}} {e}^{- \frac{{z}^{2}}{2} dz .} \qquad ( 4.1 )$$

Considering z* as positive value of the probability density function we use sign “+”:

$$\frac{1}{2} \pm \frac{1}{\sqrt{2 π}} {\int }_{0}^{{z}_{0}} {e}^{- \frac{{z}^{2}}{2}} dz = \frac{1}{2} \pm Φ ( {z}_{0} ) , \\ Where Φ ( {z}_{0} ) = Φ ( \frac{Υ}{2} ) = 0.4032 . \qquad ( 4.11 )$$

Then new 0^{th} and 100^{th} percentiles will be calculated by next formulas:

$${c}_{j , p 1} = {c}_{j , p 3} + 1.3 \cdot \frac{M {V}_{sigma , j}}{\sqrt{5}} , j = \overline{1 , 3 ,} \qquad ( 4.12 )$$

$${c}_{j , p 5} = {c}_{j , p 3} + 1.3 \cdot \frac{M {V}_{sigma , j}}{\sqrt{5}} , j = \overline{1 , 3.} \qquad ( 4.13 )$$

Assume 25^{th} and 75^{th} percentiles are in range between [0, 50] and [50, 100] correspondingly then

$${c}_{j , p 2} = \frac{1}{2} ( {c}_{j , p 1} + {c}_{j , p 3} ) , j = \overline{1 , 3.} \qquad ( 4.14 )$$

$${c}_{j , p 4} = \frac{1}{2} ( {c}_{j , p 3} + {c}_{j , p 5} ) , j = \overline{1 , 3.} \qquad ( 4.15 )$$

In summary, unknown vector c̅ of Compensation Pay can be calculated by formulas (4.7), (4.12), (4.13), (4.14), (4.15).
4.2 Reinforcement ML system
4.3 Weekly data re-adjustments

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1-16. (canceled)

17. A method for use in providing compensation information, comprising:
obtaining market information concerning compensation for a market of interest, wherein said obtaining market information involves receiving feedback compensation information from a user and employing said feedback compensation information for determining compensation estimates;
establishing a compensation model for said market of interest; receiving a query concerning a compensation value for a defined position, wherein said compensation model is a statistically derived model covering one or more standardized position descriptions in a defined market vertical;
operating a predictive compensation module to use said compensation model and said market information to predict a closing price estimate in relation to said compensation value; and
providing, to a user, a report including information regarding a specific compensation value in relation to said closing time estimate.

18. The method of claim 17, wherein said market information is obtained from a plurality of sources and concerns one or more source positions and said obtaining further comprises mapping said source positions to one or more of said standardized position descriptions.

19. The method of claim 18, wherein said sources include one or more of companies, employees, applicant, compensation surveys, job listing services, and recruiters.

20. The method of claim 17, further comprising obtaining applicant information concerning the attributes or skill set of an applicant associated with said query.

21. The method of claim 17, wherein said operating comprises executing one of artificial intelligence and machine learning processing to predict said closing price estimate.

22. The method of claim 17, wherein said obtaining market information involves providing an API to integrate systems of a company.

23. A system for use in providing compensation information, comprising:
an input module for obtaining market information concerning compensation for a market of interest and receiving a query concerning a compensation value for a defined position, wherein said obtaining market information involves receiving feedback compensation information from a user and employing said feedback compensation information for determining compensation estimates;
a compensation module for establishing a compensation model for said market of interest, wherein said compensation model is a statistically derived model covering one or more standardized position descriptions in a defined market vertical;
a predictive compensation module operative for using said compensation model and said market information to predict a closing price estimate in relation to said compensation value; and
an output module for providing, to a user, a report including information regarding a specific compensation value in relation to said closing time estimate.

24. The system of claim 23, wherein said market information is obtained from a plurality of sources and concerns one or more source positions and said predictive compensation module is further operative for mapping said source positions to one or more of said standardized position descriptions.

25. The system of claim 24, wherein said sources include one or more of companies, employees, applicant, compensation surveys, job listing services, and recruiters.

26. The system of claim 23, wherein said predictive compensation module is further operative for obtaining applicant information concerning the attributes or skill set of an applicant associated with said query.

27. The system of claim 23, wherein said predictive compensation module is further operative for executing one of artificial intelligence and machine learning processing to predict said closing price estimate.

28. The method of claim 23, wherein said input module involves providing an API to integrate systems of a company.
